(19) United States
(12) Patent Application Publication
(10) Pub. No.: US 2005/0088160 A1
(43) Pub. Date: Apr. 28, 2005

(54) Multi output DC-DC converter

(75) Inventors: Jun Tanaka, Takatsuki-shi (JP); Tsukasa Kawahara, Nagaokakyo-shi (JP); Kazuhiko Nagaoka, Ibaraki-shi (JP); Satoshi Wada, Ibaraki-shi (JP); Shusaku Gotou, Kyoto-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/943,164

(22) Filed: Sep. 17, 2004

(30) Foreign Application Priority Data
Sep. 19, 2003 (JP) 2003-328081

(51) Int. Cl. G05F 1/40

(52) U.S. Cl. 323/284

(57) ABSTRACT

A multi output DC-DC converter is provided with a main switch which is turned ON and OFF at a predetermined cycle, and applies the input DC voltage of the DC power source to the inductor when turned ON; a plurality of diodes which rectify a voltage generated in the inductor when the main switch is off; an auxiliary switch connected in series to each of the plurality of diodes; and a plurality of capacitors connected to the respective series circuits of the plurality of diodes and the auxiliary switch, which respectively output a plurality of output voltages. And a control circuit performs a time-division control of turning the main switch ON and OFF in the predetermined cycle, and of selecting one of the plurality of auxiliary switches in the predetermined cycle, to thereby output an output voltage through the selected auxiliary switch, and, in the case where an enable signal is instructing to stop, forcefully turns OFF the auxiliary switch corresponding to the enable signal.

### BACKGROUND OF THE INVENTION

1. Field of the Invention

The present invention relates to a multi output DC-DC converter, more particularly to a multi output DC-DC converter capable of outputting a plurality of conversion DC voltages of a different magnitude utilizing a single inductor, which allows setting an activating timing of a converting operation as desired with respect to a plurality of conversion DC voltages, so as to start outputting a plurality of conversion DC voltages at a desired timing.

2. Prior Art

Prior art of the multi output DC-DC converter includes a multi output DC-DC converter provided with a plurality of step-up converters served by a single inductor in common. Among such multi output DC-DC converters, a multi output DC-DC converter in which only step-up channels are provided in plurality is known, which is shown in FIG. 13 (For example, refer to JP-A Laid Open No.2002-354822).

To this multi output DC-DC converter, an input DC voltage Ei is input from a DC power source 1, as shown in FIG. 13. And the multi output DC-DC converter is provided with a step-up circuit including an inductor 2, a main switch SW1, an auxiliary switch SW2, a diode 31, a first output capacitor 41, a diode 32 constituting a series circuit with the auxiliary switch SW2, a second output capacitor 42, and a control circuit 60 which drives the main switch SW1 and the auxiliary switch SW2 in a predetermined ON period and OFF period.

The first output capacitor 41 outputs a first output voltage VO1 to a first load 51, and the second output capacitor 42 outputs a second output voltage VO2 to a second load 52. The input/output condition is VO1>Ei>0, and also VO2>Ei>0. When the auxiliary switch SW2 is OFF, the inductor 2, the main switch SW1, the diode 31 and the capacitor 41 constitute a step-up converter. By contrast, when the auxiliary switch SW2 is ON, the inductor 2, the main switch SW1, the diode 32 and the capacitor 42 constitute a step-up converter.

In the control circuit 60, an output detector 70 detects the first output voltage VO1 and the second output voltage VO2 respectively, and amplifies an error from the respective desired values so as to output an error voltage Ve1 and an error voltage Ve2. An oscillator 61 outputs a sawtooth voltage Vt having a predetermined cycle T and a clock signal Vt1. A pulse width modulator (PWM) 80 outputs a signal V1 representing a comparison result of the error voltage Ve1 and the sawtooth voltage Vt, and a signal V2 representing a comparison result of the error voltage Ve2 and the sawtooth voltage Vt. A frequency divider 62 receives an input of the signal Vt1, and outputs a frequency division signal Vt2. A driver 90 receives an input of the signal V1, the signal V2 and the frequency division signal Vt2, and outputs a driving signal Vg1 for the main switch SW1 and a driving signal Vg2 for the auxiliary switch SW2. The driving signal Vg2 is equivalent to the frequency division signal Vt2. Also, when outputting the driving signal Vg1 for the main switch SW1, the signal V1 is selectively output when the frequency division signal Vt2 is at a low level, and the signal V2 is selectively output when the frequency division signal Vt2 is at a high level.

FIG. 14 is a waveform graph showing a current IL that runs through the foregoing signals and the inductor 2.

Referring to FIG. 13 and FIG. 14, an ordinary operation of the multi output DC-DC converter according to the prior art will be described hereunder. Firstly, it is assumed that the frequency division signal Vt2 is set at a low level by the clock signal Vt1 and the sawtooth signal Vt starts to rise, at the time t0 in FIG. 14. At this moment, the auxiliary switch SW2 is turned OFF by the frequency division signal Vt2, i.e. the driving signal Vg2, which are at the low level. On the other hand, the signal V1 representing a comparison result of the sawtooth signal Vt and the error voltage Ve1 rises to a high level, and the signal V1 is output as the driving signal Vg1. Accordingly, the main switch SW1 is turned ON, and the input DC voltage Ei is applied to the inductor 2 so that an electromagnetic energy is stored. When the signal V1 falls to the low level at the time t1, the driving signal Vg1 falls to the low level, and the main switch SW1 is turned OFF. At this moment, since the auxiliary switch SW2 is OFF, the electromagnetic energy stored in the inductor 2 is discharged as a current for charging the capacitor 41 through the diode 31. This current decreases, finally to be zero. At the time t2, the frequency division signal Vt2 is set at the high level by the clock signal Vt1, and the sawtooth signal Vt rapidly drops and then starts to rise again. At this moment, the driving signal Vg2 also rises to the high level, and the auxiliary switch SW2 is turned ON. On the other hand, the signal V2 representing a comparison result of the sawtooth signal Vt and the error voltage Ve2 rises to the high level, and the signal V2 is output as the driving signal Vg1. Accordingly, the main switch SW1 is turned ON. At this moment, the input DC voltage Ei is applied to the inductor 2 so that an electromagnetic energy is stored. When the signal V2 falls to the low level at the time t3, the driving signal Vg1 falls to the low level, and the main switch SW1 is turned OFF. At this moment, since the auxiliary switch SW2 is ON, the electromagnetic energy stored in the inductor 2 is discharged as a current for charging the capacitor 42 through the diode 32. This current decreases, finally to be zero. At the time t4, the driving signal Vg2 falls to the low level, and repeats the actions taken since the time t0. The error voltages Ve1 and Ve2 respectively increase or decrease so as to stabilize the first and the second output voltages VO1 and VO2 at a desired voltage, therefore an ON period of the main switch SW1 can be adjusted. More specifically, two step-up converters utilizing the main switch SW1 and the inductor 2 in common are controlled in a time-division manner at half an oscillating frequency of the oscillator 61, because of which the first and the second output voltages are respectively stabilized at a desired voltage.

In the multi output DC-DC converter according to the prior art, which utilizes a single inductor for multiple outputs in common, a logical waveform for controlling the ON/OFF of the switches SW1 and SW2 is uniquely designed, such that all the output voltages alternately repeat the step-up action throughout a period from starting to activate the circuit, through a normal operation and to stopping the circuit. Therefore, when activating the circuit, all the output voltages start to be activated at a time, and when stopping the circuit the step-up actions of all the outputs are stopped.

Further, because of the input condition of VO1>VO2>Ei, in a period when the auxiliary switch SW2 is ON in FIG. 13, an anode-side voltage of the diode 32 is fixed at (output voltage VO2+forward diode voltage). Accordingly, a step-up energy stored and generated in the inductor 2 during such period is not utilized for the step-up of the first output voltage VO1, but is exclusively utilized as the step-up energy of the second output voltage VO2.

However, in the case of first starting to activate the second output voltage VO2, and then starting to activate the first output voltage VO1 after the second output voltage VO2 has been stabilized, a state of VO2>VO1 is temporarily incurred during a period from starting to activate the second output voltage VO2 to completion of the step-up of the first output voltage VO1, which disables the control since such state is not in compliance with the input condition.

### SUMMARY OF THE INVENTION

It is an object of the present invention to provide a multi output DC-DC converter constituted so as to utilize a single inductor in common for multiple outputs, which allows setting each output voltage as desired irrespective of another output voltage.

It is another object of the present invention to provide a multi output DC-DC converter designed to utilize a single inductor in common for multiple outputs, which allows starting to activate and stopping with a desired time difference in the starting and stopping timing of each output voltage.

For achieving the foregoing object, a multi output DC-DC converter according to a first aspect of the present invention comprises a DC power source which outputs an input DC voltage; an inductor connected to the DC power source; a main switch which is turned ON and OFF at a predetermined cycle, and applies the input DC voltage of the DC power source to the inductor when turned ON; a plurality of rectifying means which rectify a voltage generated in the inductor when the main switch is off; an auxiliary switches connected in series to each of the plurality of rectifying means; a plurality of smoothing means connected to the respective series circuits of the plurality of rectifying means and the auxiliary switches, which respectively output a plurality of output voltages; and a control circuit.

The control circuit performs a time-division control of turning the main switch ON and OFF in the predetermined cycle, and of selecting one of the plurality of auxiliary switches in the predetermined cycle, to thereby output an output voltage through the selected auxiliary switch, and, in the case where an enable signal is instructing to stop, forcefully turns OFF an auxiliary switch corresponding to the enable signal.

Such constitution allows setting each output voltage as desired irrespective of another output voltage. This constitution also allows starting to activate with a time difference in the starting timing of each output voltage, and stopping with a time difference in the stopping timing of each output voltage.

Here, in the case where the enable signal is instructing to stop, it is preferable to turn the main switch OFF, during a period that an auxiliary switch for outputting the corresponding output voltage is selected.

Also, it is preferable that the control circuit controls an energy storing time of the inductor such that the output voltage corresponding to the auxiliary switch matches a predetermined target voltage, during a period that an auxiliary switch for outputting the corresponding output voltage is selected, and causes the inductor to discharge a stored energy to the corresponding smoothing means among the plurality of smoothing means. As a result, a voltage of a plurality of output terminals is stabilized at a desired voltage.

A multi output DC-DC converter according to a second aspect of the present invention comprises a DC power source which outputs an input DC voltage; an inductor; a first main switch connected in series between the inductor and ground; a second main switch connected in series between the DC power source and the inductor; a first rectifying means connected to a node of the first main switch and the inductor; a first smoothing means connected in series to the first rectifying means, for outputting a positive voltage; a second rectifying means connected to a node of the second main switch and the inductor; a second smoothing means connected in series to the second rectifying means, for outputting a negative voltage; and a control circuit.

The control circuit alternately selects a first state of outputting a positive voltage and a second state of outputting a negative voltage in a predetermined cycle; keeps the second main switch ON and turns the first main switch ON and OFF so as to rectify a voltage generated in the inductor with the first rectifying means, during a period of the first state; keeps the first main switch ON and turns the second main switch ON and OFF so as to rectify a voltage generated in the inductor with the second rectifying means, during a period of the second state; turns OFF the first main switch during a period that a first enable signal for a positive voltage is instructing to stop, but only during a period of the first state; and turns OFF the second main switch during a period that a second enable signal for a negative voltage is instructing to stop, but only during a period of the second state.

Such constitution allows setting each output voltage as desired irrespective of another output voltage. This constitution also allows starting to activate with a time difference in the starting timing of each output voltage, and stopping with a time difference in the stopping timing of each output voltage.

Here, it is preferable that the control circuit controls an energy storing time of the inductor such that the output voltage corresponding to the auxiliary switch matches a predetermined target voltage, during a period of the first state or the second state, and causes the inductor to discharge a stored energy to the corresponding smoothing means among the plurality of smoothing means. As a result, a voltage of a plurality of output terminals is stabilized at a desired voltage.

As described above, the multi output DC-DC converter according to the present invention is provided with the foregoing constitution, which allows setting each output voltage as desired irrespective of another output voltage. This constitution also allows starting to activate and stopping with a desired time difference in the starting and stopping timing of each output voltage.

### BRIEF DESCRIPTION OF THE DRAWINGS

FIG. 1 is a circuit diagram showing a configuration of a sequential activation multi output DC-DC converter with two step-up outputs, according to the embodiment 1 of the present invention;

FIG. 2 is a waveform graph showing an operation of the sequential activation multi output DC-DC converter with two step-up outputs, according to the embodiment 1 of the present invention;

FIG. 3 is a waveform graph showing a combination of an inputting order of an activating sequence, according to the embodiment 1 of the present invention;

FIG. 4 is a waveform graph showing a combination of an inputting order of a stopping sequence, according to the embodiment 1 of the present invention;

FIG. 5 is a circuit diagram showing a configuration of a sequential activation multi output DC-DC converter with a step-up output and an inverted output, according to the embodiment 2 of the present invention;

FIG. 6 is a waveform graph showing an operation of the sequential activation multi output DC-DC converter with a step-up output and an inverted output, according to the embodiment 2 of the present invention;

FIG. 7 is a waveform graph showing a combination of an inputting order of an activating sequence, according to the embodiment 2 of the present invention;

FIG. 8 is a waveform graph showing a combination of an inputting order of a stopping sequence, according to the embodiment 2 of the present invention;

FIG. 9 a circuit diagram showing an configuration of a multi output DC-DC converter with two step-up outputs and two inverted outputs, according to the embodiment 3 of the present invention;

FIG. 10 is a waveform graph showing an ordinary operating state of the multi output DC-DC converter with two step-up outputs and two inverted outputs, in which all the outputs are operating, according to the embodiment 3 of the present invention;

FIG. 11 is a waveform graph showing an operating state of the sequential activation multi output DC-DC converter with two step-up outputs and two inverted outputs, in which only the two step-up outputs are operating, according to the embodiment 3 of the present invention;

FIG. 12 is a waveform graph showing an operating state of the multi output DC-DC converter with two step-up outputs and two inverted outputs, in which only one step-up output and one inverted output are operating, according to the embodiment 3 of the present invention;

FIG. 13 is a circuit diagram showing a multi output DC-DC converter according to a prior art.

FIG. 14 is a waveform graph showing an operation of the multi output DC-DC converter according to the prior art.

### DESCRIPTION OF THE PREFERRED EMBODIMENTS

Embodiment 1

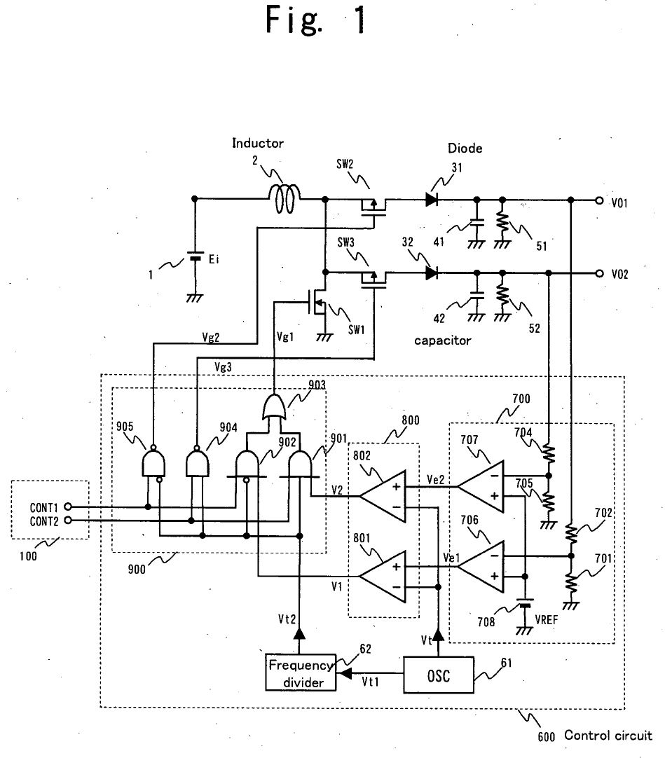

Hereunder, the embodiment 1 of the present invention will be described referring to FIG. 1.

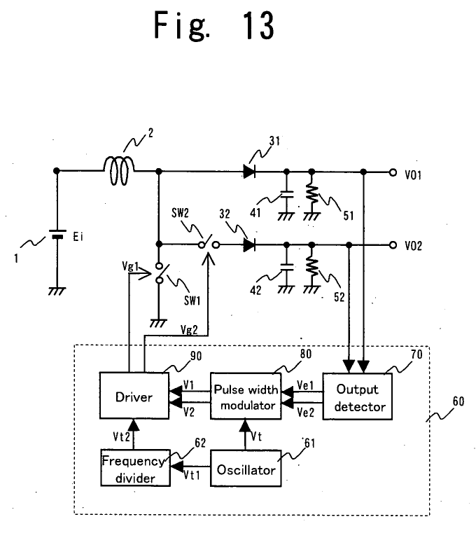

FIG. 1 is a circuit diagram showing a configuration of a multi output DC-DC converter, according to the embodiment 1 of the present invention. In FIG. 1, same constituents as those in FIG. 13 are given an identical numeral, and description thereof will be omitted.

As shown in FIG. 1, an input DC voltage Ei is being input from a DC power source 1 to the multi output DC-DC converter according to this embodiment. And this multi output DC-DC converter is provided with a step-up circuit including an inductor 2, a main switch SW1 constituted of an N-channel MOSFET, an auxiliary switch SW2 constituted of a P-channel MOSFET with a back gate thereof connected to the inductor 2, a diode 31 constituting a series circuit with the auxiliary switch SW2, a first output capacitor 41, an auxiliary switch SW3 constituted of a P-channel MOSFET with a back gate thereof connected to the inductor 2, a diode 32 constituting a series circuit with the auxiliary switch SW3, a second output capacitor 42, a control circuit 600 which drives the main switch SW1, the auxiliary switch SW2 and the auxiliary switch SW3 in a predetermined ON period and OFF period, and an enable signal input terminal 100 including input terminals CONT1 and CONT2, to which an enable signal corresponding to a first output voltage (conversion DC voltage) VO1 and a second output voltage VO2 are to be respectively input.

The main switch SW1, the auxiliary switch SW2 and the auxiliary switch SW3 constitute a switching circuit, which has the function of switching between storing an energy in the inductor 2 and discharging the energy from the inductor 2, as well as selecting an energy discharge path from the inductor 2 to the plurality of capacitors (41 or 42).

The control circuit 600 has the function of controlling the switching circuit (SW1 to SW3), such that the switching circuit cyclically switches between storing an energy in the inductor 2 and discharging the energy from the inductor 2, and exclusively selects an energy discharge path from the inductor 2 to the plurality of capacitors (41 or 42) by time-division. Also, the control circuit 600 has the function of controlling an energy storing time of the inductor 2 during a period that the corresponding discharge path is selected such that a voltage appearing at the plurality of voltage output terminals respectively matches a predetermined target voltage, and causing the inductor 2 to discharge all the stored energy to the corresponding capacitor (41 or 42) within the corresponding period. Further, the control circuit 600 has the function of selecting ON or OFF of the energy discharge path leading to the plurality of capacitors (41 or 42) according to a status of the enable signal defined corresponding to each of the plurality of auxiliary switches (SW2 and SW3), and further stopping storing an energy in the inductor 2 during a period that the energy discharge path leading to the capacitors (41 or 42) is OFF.

An output detector 700 includes detecting resistors 701, 702, 704, 705, error amplifiers 706, 707, and a reference voltage source 708 which generates a reference voltage VREF, and the first output voltage VO1 is detected by the detecting resistors 701, 702 while the second output voltage VO2 is detected by the detecting resistors 704, 705, and with respect to each voltage the error amplifiers 706, 707 respectively amplify a difference from a desired voltage, to thereby output an error voltage Ve1, Ve2.

A pulse width modulator 800 is constituted of comparators 801, 802, and outputs a signal V1 representing a comparison result of the error voltage Ve1 and a sawtooth voltage Vt, and a signal V2 representing a comparison result of the error voltage Ve2 and a sawtooth voltage Vt.

A driver 900 includes AND circuits 901, 902, OR circuit 903, and NAND circuits 904, 905.

Numerals 51, 52 designate a load.

Upon inputting a high level signal to the input terminal CONT1 in the enable signal input terminal 100, the first output voltage VO1 starts to be activated, and upon inputting a high level signal to the input terminal CONT2, the second output voltage VO2 starts to be activated. Regarding an activating sequence in the description of this embodiment, an output voltage that first starts to be activated is defined as VO2, and an output voltage that subsequently starts to be activated is defined as VO1.

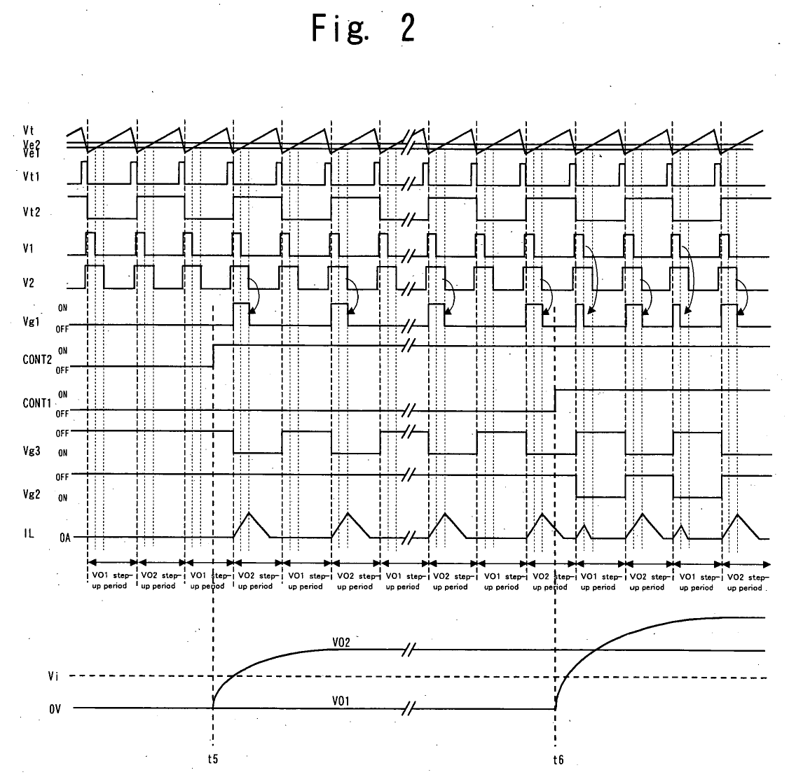

Referring to FIGS. 1 and 2, a status of starting the activation of the output voltages will be described. Before starting the activation of the first and the second output voltages VO1, VO2, the enable signal has not been input to either of the input terminals CONT1, CONT2, and a low level state is maintained. A signal of the input terminal CONT1 shuts out the pulse signal V1 from being output as a driving signal Vg1 for the main switch SW1 in the AND circuit 902. Likewise, a signal of the input terminal CONT2 shuts out the pulse signal V2 from being output as a driving signal Vg1 for the main switch SW1 in the AND circuit 901. Accordingly, an ON timing for the main switch SW1 does not exist, and hence an electromagnetic energy is not stored in the inductor 2. Also, the signals of the input terminals CONT1, CONT2 are input to the NAND circuit 905 and the NAND circuit 904, so as to constantly keep the auxiliary switches SW2, SW3 in OFF state, by fixing the driving signals Vg2, Vg3 for the auxiliary switches SW2, SW3 at a high level.

Now, the time t5 in FIG. 2 is the time that the high level is input only to the signal of the input terminal CONT2; the first output voltage VO1 has not yet started to be activated; and only the second output voltage VO2 starts to be activated. At this moment, since a low level is input to the input terminal CONT1 the AND circuit 902 does not make any output, while since the signal of the input terminal CONT2 input to the AND circuit 901 is at the high level, the AND circuit 901 outputs an AND of the frequency division signal Vt2 and the pulse signal V2. In other words, as the driving signal Vg1 for the main switch SW1, which is to be output from the OR circuit 903, only the pulse signal V2 is selectively output in a period where the frequency division signal Vt2 is at the high level.

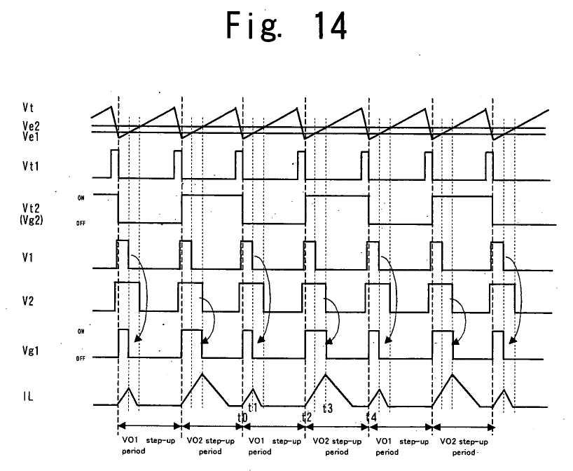

Also, since the signal of the input terminal CONT2 is at the high level, the NAND circuit 904 outputs an inverted signal of the frequency division signal Vt2, and such inverted signal becomes the driving signal Vg3 for the auxiliary switch SW3. The auxiliary switch SW3, which is a P-channel MOSFET, is turned ON when the frequency division signal Vt2 is at the high level. During this period the circuit serves as a step-up converter for the second output voltage VO2, behaving as illustrated in a period of the time t2 to t4 in FIG. 14 showing the prior art. Further, since the signal of the input terminal CONT1 is at the low level, an output of the NAND circuit 905 is fixed at the high level. Since the output of the NAND circuit 905 is the driving signal Vg2 for the auxiliary switch SW2, the auxiliary switch SW2, which is a P-channel MOSFET, remains in OFF state during a period that the first output voltage VO1 has not yet started to be activated. Therefore, an energy does not flow into an output unit of the first output voltage VO1.

Finally, the time t6 of FIG. 2 is the time that the high level is also input to the signal of the input terminal CONT1, so that the first output VO1 also starts to be activated. By changing the signal of the input terminal CONT1 to the high level, the AND circuit 902 outputs an AND of an inverted signal of the frequency division signal Vt2 and the pulse signal V1. By inputting to the OR circuit 903 this AND output signal, and the above AND output signal composed of the frequency division signal Vt2 and the pulse signal V2 output by the AND circuit 901, the pulse signal V2 is selectively output as the driving signal Vg1 for the main switch SW1 in a period that the frequency division signal Vt2 is at the high level, and the pulse signal V1 is selectively output as the driving signal Vg1 for the main switch SW1 in a period that the frequency division signal Vt2 is at the low level.

Also, since the both signals of the input terminals CONT1, CONT2 are at the high level, an output of the NAND circuit 905, i.e. the driving signal Vg2 for the auxiliary switch SW2 becomes the same signal as the frequency division signal Vt2, and an output of the NAND circuit 904, i.e. the driving signal Vg3 for the auxiliary switch SW3 becomes the inverted signal of the frequency division signal Vt2.

Therefore, the auxiliary switch SW2, which is a P-channel MOSFET, is turned ON in a period that the frequency division signal Vt2 is at the low level, and likewise the auxiliary switch SW3 is turned ON in a period that the frequency division signal Vt2 is at the high level. Accordingly, by alternately turning ON the auxiliary switch SW2 and the auxiliary switch SW3, a state of a first step-up converter (generating the first output voltage VO1), constituted of the main switch SW1, the inductor 2, the diode 31, and the output capacitor 41 is achieved during a period that the auxiliary switch SW2 is ON, and a state of a second step-up converter (generating the second output voltage VO2), constituted of the main switch SW1, the inductor 2, the diode 32 and the output capacitor 42 is achieved during a period that the auxiliary switch SW3 is ON. These two states can be construed to be mutually independent step-up circuits, in which a magnitude of the both output voltages VO1, VO2 can be set as desired. Also, it becomes possible to activate or stop either output voltages VO1, VO2 at a desired timing, irrespective of a magnitude of the output voltages VO1, VO2.

The foregoing operation refers to a case of a multi output DC-DC converter that performs a time-division control at half an oscillating frequency, such that the first step-up converter which generates the first output voltage VO1 and the second step-up converter which generates the second output voltage VO2 alternately repeat the step-up operation the same number of times, on the assumption that an output power consumption by the output voltage VO1 and an output power consumption by the output voltage VO2 are close to each other.

However, in the case where there is a certain difference between an output power consumption by the output voltage VO1 and an output power consumption by the output voltage VO2, it is preferable to make a difference between the number of operating times of the first step-up converter for generating the output voltage VO1 and the number of operating times of the second step-up converter for generating the output voltage VO2. For example, in the case where an output power consumption by the output voltage VO1 is thrice as large as an output power consumption by the output voltage VO2, a time-division control can be performed at a quarter of the oscillating frequency, such as repeating three times the step-up operation of the output voltage VO1, i.e. the behavior during a period from the time t0 to the time t2 in FIG. 14 showing the prior art, and performing once the step-up operation of the output voltage VO2, i.e. the behavior during a period from the time t2 to the time t4 in FIG. 14 showing the prior art. Accordingly, it is not necessary to alternately execute the step-up operation with respect to each individual output terminal, in the embodiment 1.

Also, while the foregoing embodiment refers to the multi output DC-DC converter provided with two output terminals, the number of the output terminals may be three or more.

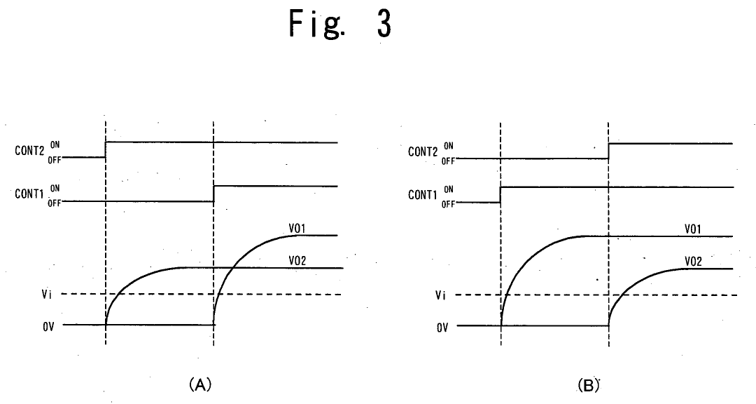

FIG. 3 is a waveform graph showing a relation between an inputting condition of the enable signal to the input terminals CONT1, CONT2 and an activating status of the output voltages VO1, VO2. FIG. 2 and the foregoing description are detailed expression of the activating status shown in FIG. 3(A). Specifically, first the activating signal (enable signal) of the input terminal CONT2 is changed to the high level from the low level, and after a predetermined time the activating signal (enable signal) of the input terminal CONT1 is changed to the high level from the low level, so as to activate in a sequence of the output voltage VO2 first and the output voltage VO1 after a predetermined time.

By contrast, as shown in FIG. 3(B), it is also possible to activate the output voltage VO1 first and the output voltage VO2 after a predetermined time, by first changing the activating signal of the input terminal CONT1 to the high level from the low level, and then changing the activating signal of the input terminal CONT2 to the high level from the low level after a predetermined time.

Also, the enable signal may be simultaneously input to the input terminals CONT1, CONT2.

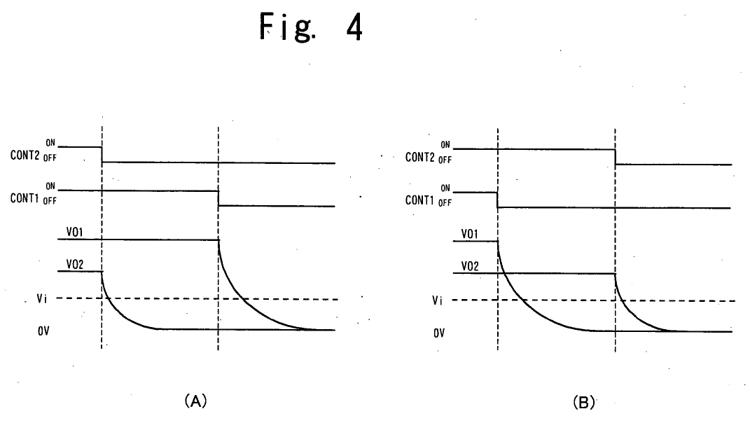

Now, FIG. 4 is a waveform graph showing a relation between an inputting condition of the enable signal to the input terminals CONT1, CONT2 and a stopping status of the output voltages VO1, VO2. As shown in FIG. 4(A), it is possible to stop in a sequence of the output voltage VO2 first and the output voltage VO1 after a predetermined time, by first changing the activating signal of the input terminal CONT2 to the low level from the high level, and then changing the activating signal of the input terminal CONT1 to the low level from the high level after a predetermined time.

By contrast, as shown in FIG. 4(B), it is also possible to stop the output voltage VO1 first and the output voltage VO2 after a predetermined time, by first changing the activating signal of the input terminal CONT1 to the high level from the low level, and then changing the activating signal of the input terminal CONT2 to the high level from the low level after a predetermined time.

Also, the stop signal may be simultaneously input to the input terminals CONT1, CONT2.

Further, it is also possible to utilize the multi output DC-DC converter as a single converter exclusively for the output voltage VO2, by fixing the activating signal of the input terminal CONT1 at the low level and raising only the activating signal of the input terminal CONT2 to the high level, and also as a single converter exclusively for the output voltage Vol, by fixing the activating signal of the input terminal CONT2 at the low level and raising only the activating signal of the input terminal CONT1 to the high level.

Embodiment 2

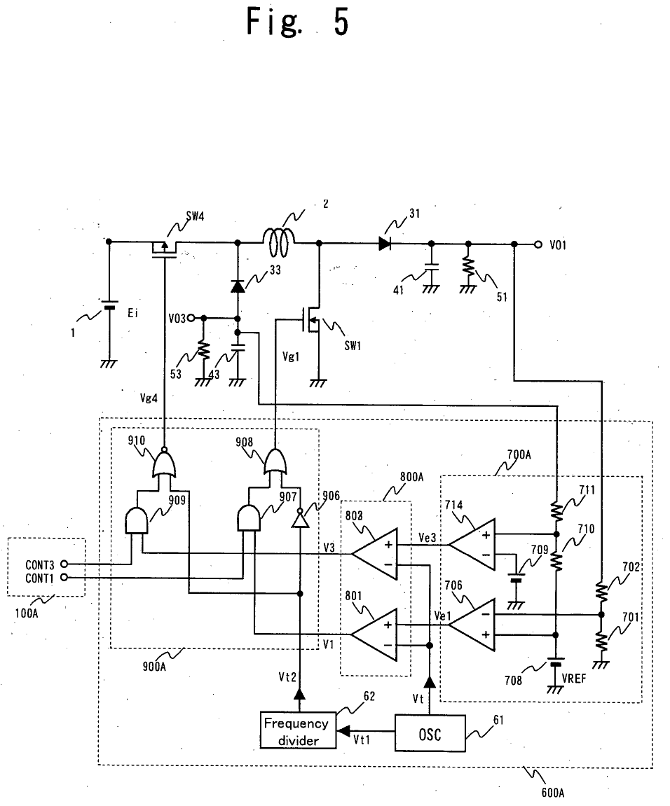

Hereunder, the embodiment 2 of the present invention will be described referring to FIG. 5.

FIG. 5 is a circuit diagram showing a configuration of a multi output DC-DC converter, according to the embodiment 2 of the present invention. The above embodiment 1 refers to the case where the present invention is applied to a multi output DC-DC converter provided with two step-up outputs. The embodiment 2 describes a case where the present invention is applied to a multi output DC-DC converter provided with one step-up output and one inverted output.

As shown in FIG. 5, an input DC voltage Ei is being input from a DC power source 1 to the multi output DC-DC converter according to this embodiment. And this multi output DC-DC converter is provided with an inductor 2, a first main switch SW1 constituted of an N-channel MOSFET, a second main switch SW4 constituted of a P-channel MOSFET, a diode 31, a first output capacitor 41, a diode 33, a second output capacitor 43, a control circuit 600A which drives the first main switch SW1 and the second main switch SW4 in a predetermined ON period and OFF period, and an enable signal input terminal 100A including an input terminal CONT1 to which an enable signal for a first output voltage VO1 is to be input, and an input terminal CONT3, to which an enable signal for a second output voltage VO3 is to be input.

An output detector 700A includes detecting resistors 701, 702, 710, 711, error amplifiers 706, 714, a reference voltage source 708 which generates a reference voltage VREF, and a reference voltage source 709 which outputs a voltage lower than the reference voltage VREF. The first output voltage VO1 is detected by the detecting resistors 701, 702, while the second output voltage VO3 is detected by the detecting resistors 710, 711. And with respect to each detected voltage, the error amplifiers 706, 714 respectively amplify a difference from a desired voltage, to thereby output an error voltage Ve1, Ve3.

A pulse width modulator 800A is constituted of comparators 801, 803, and outputs a signal V1 representing a comparison result of the error voltage Ve1 and a sawtooth voltage Vt, and a signal V3 representing a comparison result of the error voltage Ve3 and a sawtooth voltage Vt.

A driver 900A includes an inverter 906, an AND circuit 907, an OR circuit 908, an AND circuit 909 and an NOR circuit 910.

And in this multi output DC-DC converter, the first output voltage VO1 is output from the first capacitor 41 to a first load 51, and the second output voltage VO3 is output from the second capacitor 43 to a second load 53. The input/output condition is VO1>Ei>0>VO3.

Regarding the control circuit 600A, since the output detector 700A, the oscillator 61, the pulse width modulator 800A and the frequency divider 62 are the same constituents as those of the multi output DC-DC converter according to the prior art shown in FIG. 13, these are given an identical numeral and detailed description thereof will be omitted.

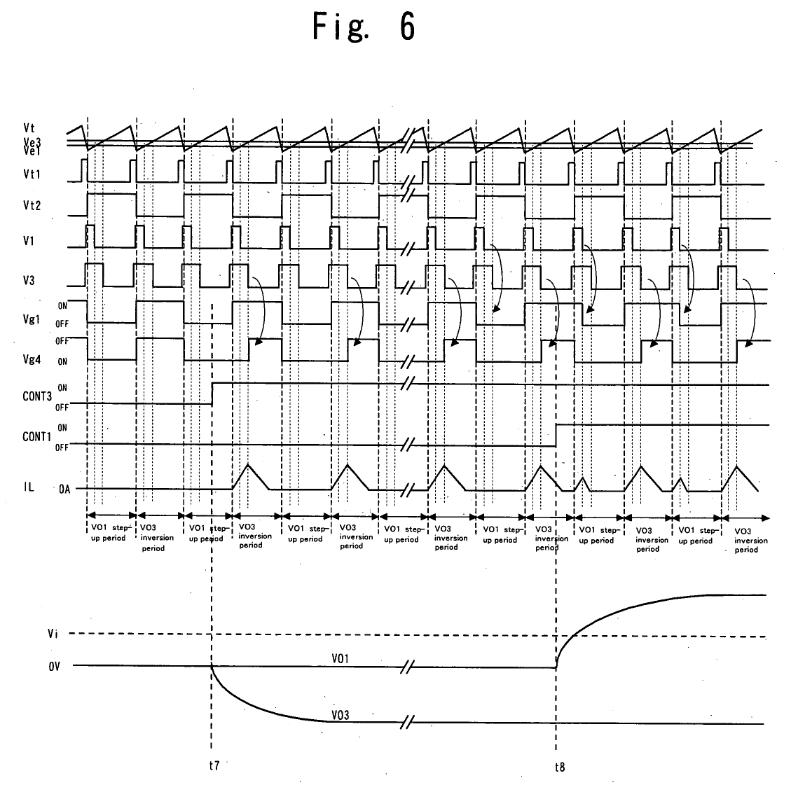

FIG. 6 is a waveform graph showing a signal of each constituent and a current IL running through the inductor 2. Now referring to FIGS. 5 and 6, a basic operation of the DC-DC converter according to the embodiment 2 of the present invention will be described.

When the first main switch SW1 is ON, the inductor 2, the second main switch SW4, the diode 33 and the capacitor 43 constitute an inverting converter, while when the second main switch SW4 is ON, the inductor 2, the first main switch SW1, the diode 31 and the capacitor 41 constitute a step-up converter.

In the control circuit 600A, the output detector 700A detects the first output voltage VO1 and the second output voltage VO3, and the error amplifiers 706, 714 amplify an error from the respective desired values so as to output the error voltage Ve1 and the error voltage Ve3. The oscillator 61 outputs a sawtooth voltage Vt having a predetermined cycle T and a clock signal Vt1. The pulse width modulator 800A outputs a signal V1 representing a comparison result of the error voltage Ve1 and the sawtooth voltage Vt, and a signal V3 representing a comparison result of the error voltage Ve3 and the sawtooth voltage Vt. A frequency divider 62 receives an input of the signal Vt1, and outputs a frequency division signal Vt2. The driver 900A receives an input of the signal V1, the signal V3, the frequency division signal Vt2 and an enable signal from the enable signal input terminal 100A, and outputs a driving signal Vg1 for the first main switch SW1 and a driving signal Vg4 for the second main switch SW4.

In the case where a signal to be input to the input terminal CONT1, which is an enable signal for the first output voltage VO1, is at a low level, the signal V1 is not output because the AND circuit 907 is closed. Accordingly, an signal inverted from the frequency division signal Vt2 by the inverter 906 is input as the driving signal Vg1 to the OR circuit 908, which outputs an inverted signal of the frequency division signal Vt2.

In the case where a signal of the input terminal CONT1, which is an enable signal for the first output voltage VO1, is at a high level, the driving signal Vg1 rises to the high level in a period that the frequency division signal Vt2 is at the low level and in a period that the signal V1 is at the high level, and turns ON the second main switch SW4 constituted of an P-MOSFET.

In the case where a signal to be input to the input terminal CONT3, which is an enable signal for the second output voltage VO3, is at a low level, the signal V3 is not output because the AND circuit 909 is closed, therefore the frequency division signal Vt2 is input as the driving signal Vg4 to the NOR circuit 910, which outputs an inverted signal of the frequency division signal Vt2.

In the case where a signal of the input terminal CONT3, which is an enable signal for the second output voltage VO3, is at a high level, the driving signal Vg4 falls to the low level in a period that the frequency division signal Vt2 is at the high level and in a period that the signal V3 is at the high level, and turns ON the second main switch SW4 constituted of an P-MOSFET.

In the case where a voltage of the both input terminals CONT1, CONT2, which are the enable signal input terminal 100A, is at the low level, an inverted signal of the frequency division signal Vt2 is output as the driving signal Vg1 and as the driving signal Vg4, and the first main switch SW1 which is an N-MOSFET and the second main switch SW4 which is a P-MOSFET are alternately turned ON and OFF. Accordingly, a charging current from the DC power source 1 is not supplied to the inductor 2 for storing an electromagnetic energy, and both output voltages VO1, VO3 are zero.

Then, at the time t7 in FIG. 6, when an input signal to the input terminal CONT3, which is an enable signal for the second output voltage VO3, rises to the high level, the signal V3 is input to the NOR circuit 910 by the AND circuit 909 in addition to the frequency division signal Vt2, and the driving signal Vg4 falls to the low level in a period that the frequency division signal Vt2 is at the high level and a period that the signal V3 is at the high level, to thereby turn ON the second main switch SW4 constituted of a P-MOSFET. As a result, the first main switch SW1 which is an N-MOSFET and the second main switch SW4 which is a P-MOSFET are simultaneously turned ON during a period that the signal V3 is at the high level, so that an electromagnetic energy is stored in the inductor 2. Subsequently, when the signal V3 falls to the low level and the driving signal Vg4 rises to the high level so as to turn OFF the second main switch SW4 which is a P-MOSFET, the electromagnetic energy stored in the inductor 2 starts to charge the capacitor 43 toward a negative potential through the diode 33, so as to generate the second output voltage VO3, which is an inverted output voltage. Regarding the driving signal Vg4, a signal in such a state is continuously repeated.

Now at the time t8 of FIG. 6, when an input signal to the input terminal CONT1, which is an enable signal for the second output voltage VO1, rises to the high level, the signal V1 is input to the OR circuit 908 by the AND circuit 907 in addition to the frequency division signal Vt2, and the driving signal Vg1 rises to the high level in a period that the frequency division signal Vt2 is at the low level and a period that the signal V1 is at the high level, to thereby turn ON the first main switch SW1 constituted of an N-MOSFET. As a result, the first main switch SW1 which is an N-MOSFET and the second main switch SW4 which is a P-MOSFET are simultaneously turned ON during a period that the signal V1 is at the high level, so that an electromagnetic energy is stored in the inductor 2. Subsequently, when the signal V1 falls to the low level and the driving signal Vg1 falls to the low level so as to turn OFF the first main switch SW1 which is an N-MOSFET, the electromagnetic energy stored in the inductor 2 starts to charge the capacitor 41 to a higher potential than the input DC voltage Ei through the diode 31. Further, since the inverting operation of the second output voltage VO3 has been performed since the time t7, the inductor 2 is charged in a high level time of the signal V1 in a period that the frequency division signal Vt2 is at the high level, so as to output the second output voltage VO3, which is an inverted output voltage.

Also, the error voltages Ve1 and Ve3 increase or decrease the first and the second output voltages VO1 and VO3 so as to stabilize at a desired voltage, so that an ON period of the first main switch SW1 and the second main switch SW4 is adjusted. In other words, the step-up converter and the inverting converter utilizing the inductor 2 in common are subjected to a time-division control at half an oscillating frequency, so that the first output voltage VO1 and the second output voltage VO3 are stabilized at a desired voltage. Also, it is possible to stop at a desired timing by changing the signals input to the input terminals CONT1, CONT3 from the high level to the low level so as to cause a reverse operation to the foregoing description.

Adopting the above circuit configuration allows activating and stopping each output voltage at a desired timing by a multi output DC-DC converter provided with a step-up output and an inverted output. Also, the step-up output and the inverted output can be adjusted as desired, irrespective of a voltage of each other.

The foregoing operation refers to a case of a multi output DC-DC converter that performs a time-division control at half an oscillating frequency, such that the step-up converter which generates the first output voltage VO1 and the inverting converter which generates the second output voltage VO3 alternately repeat the step-up operation and the inverting operation the same number of times, on the assumption that an output power consumption by the output voltage VO1 and an output power consumption by the output voltage VO3 are close to each other.

However, in the case where there is a certain difference between an output power consumption by the output voltage VO1 and an output power consumption by the output voltage VO3, it is preferable to make a difference between the number of operating times of the step-up converter for generating the output voltage VO1 and the number of operating times of the inverting converter for generating the output voltage VO3. Accordingly, it is not necessary to alternately execute the step-up operation and the inverting operation with respect to each individual output terminal in the embodiment 2, as in the embodiment 1.

Also, while the foregoing embodiment refers to the multi output DC-DC converter provided with one step-up output terminal and one inverted output terminal, the number of the step-up output terminal may be two or more. The number of the inverted output terminal may be at least one, in other words may be two or more.

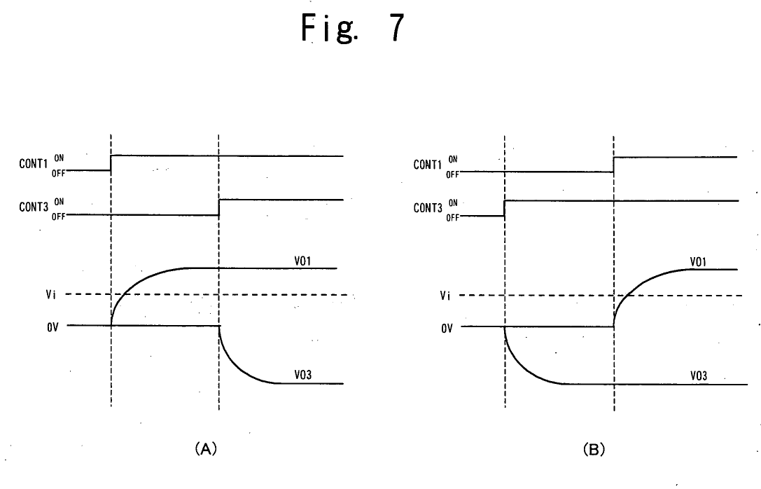

FIG. 7 is a waveform graph showing a relation between an inputting condition of the enable signal to CONT1, CONT3 and an activating status of the output voltages VO1, VO3. FIG. 6 and the foregoing description are detailed expression of the activating status shown in FIG. 7(B). Specifically, first the activating signal (enable signal) of the input terminal CONT3 is changed to the high level from the low level, and after a predetermined time the activating signal (enable signal) of the input terminal CONT1 is changed to the high level from the low level, so as to activate in a sequence of the output voltage VO3 first and the output voltage VO1 after a predetermined time.

By contrast, as shown in FIG. 7(A), it is also possible to activate the output voltage VO1 first and the output voltage VO3 after a predetermined time, by first changing the activating signal of the input terminal CONT1 to the high level from the low level, and then changing the activating signal of the input terminal CONT3 to the high level from the low level after a predetermined time. Also, the enable signal may be simultaneously input to the input terminals CONT1, CONT3.

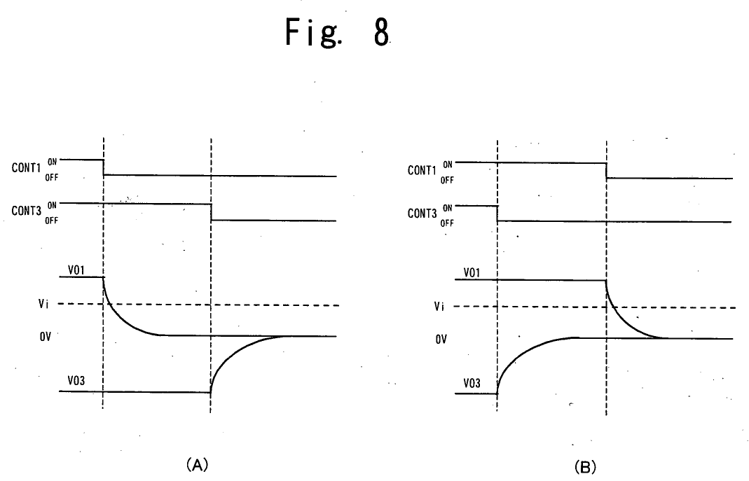

Now, FIG. 8 is a waveform graph showing a relation between an inputting condition of the enable signal to the input terminals CONT1, CONT3 and a stopping status of the output voltages VO1, VO3. As shown in FIG. 8(A), it is possible to stop in a sequence of the output voltage VO1 first and the output voltage VO3 after a predetermined time, by first changing the activating signal of the input terminal CONT1 to the low level from the high level, and then changing the activating signal of the input terminal CONT3 to the low level from the high level after a predetermined time.

By contrast, as shown in FIG. 8(B), it is also possible to stop the output voltage VO1 first and the output voltage VO3 after a predetermined time, by first changing the activating signal of the input terminal CONT3 to the low level from the high level, and then changing the activating signal of the input terminal CONT1 to the low level from the high level after a predetermined time.

Further, it is also possible to utilize the multi output DC-DC converter as a single inverting converter exclusively for the output voltage VO3, by fixing the activating signal of the input terminal CONT1 at the low level and raising only the activating signal of the input terminal CONT3 to the high level, and also as a single step-up converter exclusively for the output voltage VO1, by fixing the activating signal of the input terminal CONT3 at the low level and raising only the activating signal of the input terminal CONT1 to the high level.

Embodiment 3

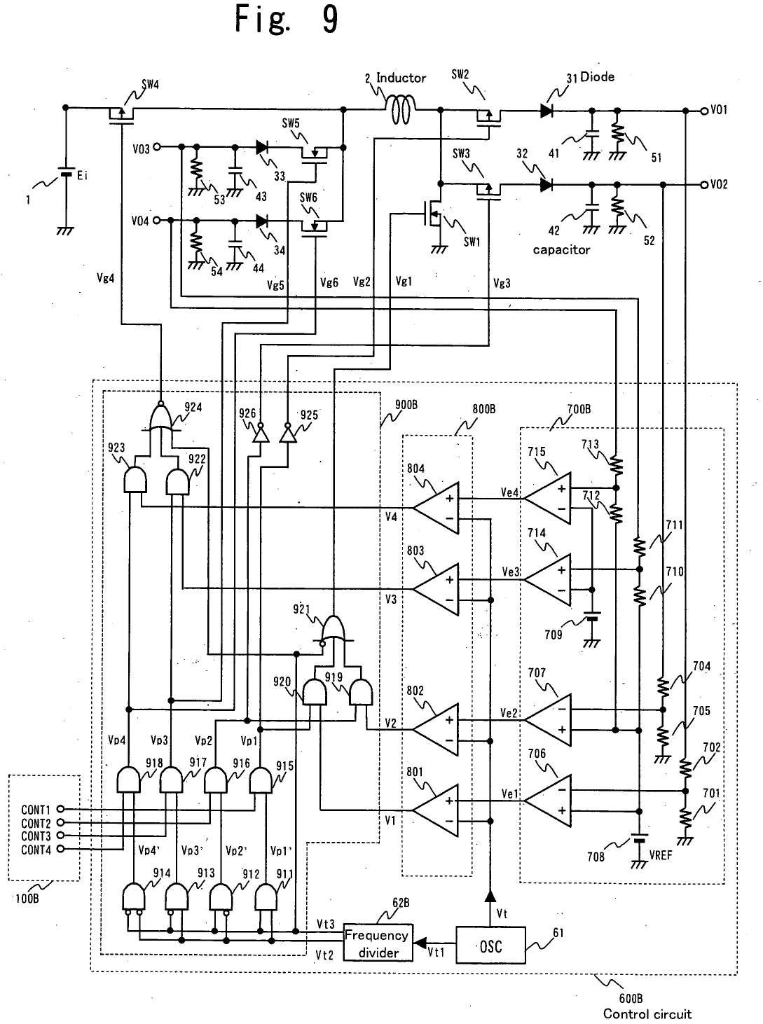

Hereunder, the embodiment 3 of the present invention will be described referring to FIG. 9.

FIG. 9 a circuit diagram showing a configuration of a multi output DC-DC converter, according to the embodiment 3 of the present invention. The foregoing embodiment 1 refers to the case where the present invention is applied to a multi output DC-DC converter provided with two step-up outputs. Also, the embodiment 2 describes a case where the present invention is applied to a multi output DC-DC converter provided with one step-up output and one inverted output. This embodiment 3 describes a case where the present invention is applied to a multi output DC-DC converter provided with two step-up outputs and two inverted outputs.

As shown in FIG. 9, an input DC voltage Ei is being input from a DC power source 1 to the multi output DC-DC converter according to the embodiment 3. And this multi output DC-DC converter is provided with an inductor 2, a first main switch SW1 constituted of an N-channel MOSFET, a second main switch SW4 constituted of a P-channel MOSFET, an auxiliary switch SW2 constituted of a P-channel MOSFET with a back gate thereof connected to the inductor 2, a diode 31 constituting a series circuit with the auxiliary switch SW2, a first output capacitor 41, an auxiliary switch SW3 constituted of a P-channel MOSFET with a back gate thereof connected to the inductor 2, a diode 32 constituting a series circuit with the auxiliary switch SW3, a second output capacitor 42, an auxiliary switch SW5 constituted of an N-channel MOSFET with a back gate thereof connected to the inductor 2, a diode 33 constituting a series circuit with the auxiliary switch SW5, a third output capacitor 43, an auxiliary switch SW6 constituted of an N-channel MOSFET with a back gate thereof connected to the inductor 2, a diode 34 constituting a series circuit with the auxiliary switch SW6, a fourth output capacitor 44, a control circuit 600B and an enable signal input terminal 100B.

The control circuit 600B drives the first main switch SW1, the second main switch SW4, the auxiliary switch SW2, the auxiliary switch SW3, the auxiliary switch SW5 and the auxiliary switch SW6, in a predetermined ON period and OFF period.

The enable signal input terminal 100B includes an input terminal CONT1 to which an enable signal for a first output voltage VO1 is to be input, an input terminal CONT2 to which an enable signal for a second output voltage VO2 is to be input, an input terminal CONT3 to which an enable signal for a third output voltage VO3 is to be input, and an input terminal CONT4, to which an enable signal for a fourth output voltage VO4 is to be input.

An output detector 700B includes detecting resistors 701, 702, 704, 705, 710, 711, 712, 713, error amplifiers 706, 707, 714, 715, a reference voltage source 708 which generates a reference voltage VREF, and a reference voltage source 709 which outputs a voltage lower than the reference voltage VREF. The first output voltage VO1 is detected by the detecting resistors 701, 702; the second output voltage VO2 is detected by the detecting resistors 704, 705; the third output voltage VO3 is detected by the detecting resistors 710, 711; and the fourth output voltage VO4 is detected by the detecting resistors 712, 713. And with respect to each detected voltage, the error amplifiers 706, 707, 714, 715 respectively amplify a difference from a desired voltage, to thereby output an error voltage Ve1, Ve2, Ve3, Ve4.

A pulse width modulator 800B is constituted of comparators 801, 802, 803, 804. And the pulse width modulator 800B outputs a signal V1 representing a comparison result of the error voltage Ve1 and a sawtooth voltage Vt, a signal V2 representing a comparison result of the error voltage Ve2 and a sawtooth voltage Vt, a signal V3 representing a comparison result of the error voltage Ve3 and a sawtooth voltage Vt, and a signal V4 representing a comparison result of the error voltage Ve4 and a sawtooth voltage Vt.

A driver 900B includes AND circuits 911 to 920, an OR circuit 921, AND circuits 922, 923, an NOR circuit 924 and inverters 925, 926.

In this multi output DC-DC converter, the first output voltage VO1 is output from the first output capacitor 41 to a first load 51; the second output voltage VO2 is output from the second output capacitor 42 to a second load 52; the third output voltage VO3 is output from the third output capacitor 43 to a third load 53; and the fourth output voltage VO4 is output from the fourth output capacitor 44 to a fourth load 54. The input/output condition in this case is VO1>Ei>0, VO2>Ei, 0>VO3 and 0>VO4.

In the control circuit 600B, since the oscillator 61 is the same constituent as that of the multi output DC-DC converter according to the prior art shown in FIG. 13, an identical numeral is given thereto and detailed description thereof will be omitted.

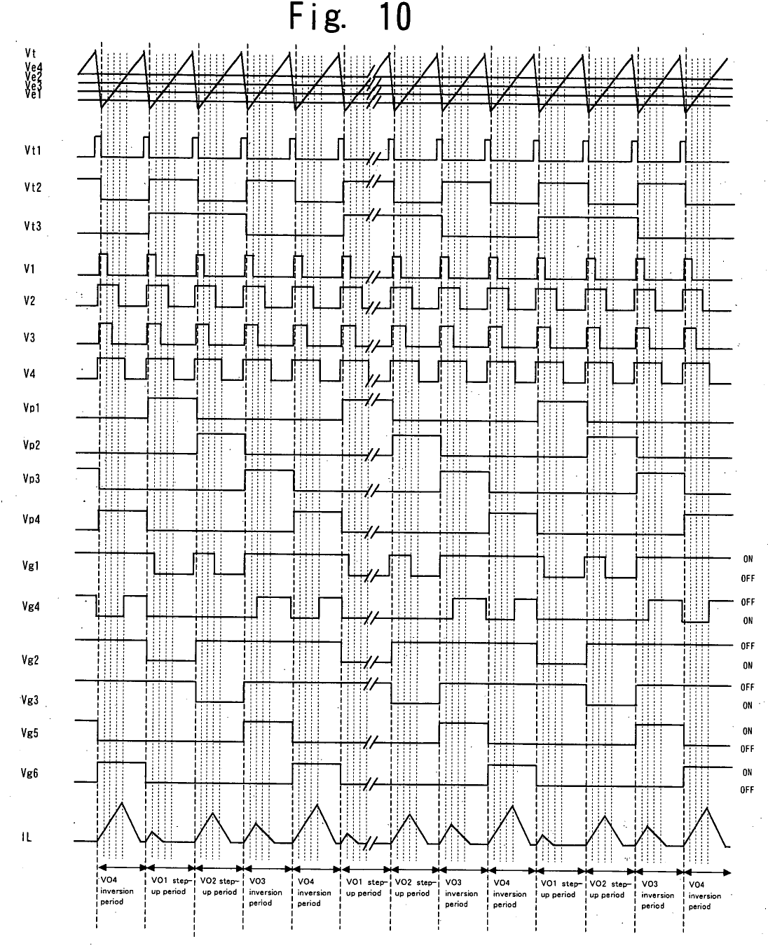

FIGS. 10, 11 and 12 are waveform graphs showing a signal of each constituent shown in FIG. 9 and a current IL running through the inductor 2. Referring to FIGS. 9 and 10, a basic operation of the DC-DC converter according to the embodiment 3 of the present invention will be described.

When the second main switch SW4 is ON and the first auxiliary switch SW2 is also ON, the inductor 2, the first main switch SW1, the first auxiliary switch SW2, the diode 31 and the capacitor 41 constitute a first step-up converter. When the second main switch SW4 is ON and the second auxiliary switch SW3 is also ON, the inductor 2, the first main switch SW1, the second auxiliary switch SW3, the diode 32 and the capacitor 42 constitute a second step-up converter.

On the other hand, when the first main switch SW1 is ON and the third auxiliary switch SW5 is also ON, the inductor 2, the second main switch SW4, the third auxiliary switch SW5, the diode 33 and the capacitor 43 constitute a first inverting converter. Also, when the first main switch SW1 is ON and the fourth auxiliary switch SW6 is also ON, the inductor 2, the second main switch SW4, the fourth auxiliary switch SW6, the diode 34 and the capacitor 44 constitute a second inverting converter.

In the control circuit 600B, the output detector 700B detects the first output voltage VO1, the second output voltage VO2, the third output voltage VO3 and the fourth output voltage VO4. And the error amplifiers 706,707, 714, 715 amplify an error from the respective desired values, so as to output the error voltage Ve1, the error voltage Ve2, the error voltage Ve3 and the error voltage Ve4 respectively.

The pulse width modulator 800B outputs the signal V1 representing a comparison result of the error voltage Ve1 and a sawtooth voltage Vt, the signal V2 representing a comparison result of the error voltage Ve2 and a sawtooth voltage Vt, the signal V3 representing a comparison result of the error voltage Ve3 and a sawtooth voltage Vt, and the signal V4 representing a comparison result of the error voltage Ve4 and a sawtooth voltage Vt.

The frequency divider 62B receives an input of the signal Vt1, and outputs a frequency division signal Vt2 divided in a half, and a frequency division signal Vt3 divided in a quarter.

The driver 900B receives an input of the signal V1, the signal V2, the signal V3, the signal V4, the frequency division signal Vt2, the frequency division signal Vt3 and an enable signal from the enable signal input terminal 100B, and outputs the driving signal Vg1 for the first main switch SW1, the driving signal Vg4 for the second main switch SW4, the driving signal Vg2 for the first auxiliary switch SW2, the driving signal Vg3 for the second auxiliary switch SW3, the driving signal Vg5 for the third auxiliary switch SW5, and the driving signal Vg6 for the fourth auxiliary switch SW6.

Firstly, an operation under an ordinary state will be described, which includes inputting a high level to all of the input terminal CONT1 for an enable signal of the first output voltage VO1, the input terminal CONT2 for an enable signal of the second output voltage VO2, the input terminal CONT3 for an enable signal of the third output voltage VO3, and the input terminal CONT4 for an enable signal of the fourth output voltage VO4, so that all the output terminals output a step-up voltage or an inverted voltage.

An output from the AND circuit 911 based on a half frequency signal Vt2 and a quarter frequency signal Vt3 output by the frequency divider 62B will be denoted as a signal Vp1′, an output from the AND circuit 912 based on an inverted signal of the half frequency signal Vt2 and the quarter frequency signal Vt3 as the signal Vp2′, an output from the AND circuit 913 based on the half frequency signal Vt2 and an inverted signal of the quarter frequency signal Vt3 as the signal Vp3′, and an output from the AND circuit 914 based on an inverted signal of the half frequency signal Vt2 and an inverted signal of the quarter frequency signal Vt3 as the signal Vp4′, and a high level period of the signals Vp1′, Vp2′, Vp3′, Vp4′ will be defined as a “step-up period of the voltage VO1”, a “step-up period of the voltage VO2”, an “inverting period of the voltage VO3” and an “inverting period of the voltage VO4”, respectively.

An AND Vp1 output by the AND circuit 915, based on the signal Vp1′ and an input signal to the input terminal CONT1 for an enable signal of the voltage VO1, is output at a high level in the “step-up period of the voltage VO1”, only in such a case that both of the signal Vp1′ and the input signal to the input terminal CONT1 for an enable signal of the voltage VO1 are at the high level.

Also, an AND Vp2 output by the AND circuit 916, based on the signal Vp2′ and an input signal to the input terminal CONT2 for an enable signal of the voltage VO2, is output at a high level in the “step-up period of the voltage VO2”, only in such a case that both of the signal Vp2′ and the input signal to the input terminal CONT2 for an enable signal of the voltage VO2 are at the high level.

Also, an AND Vp3 output by the AND circuit 917, based on the signal Vp3′ and an input signal to the input terminal CONT3 for an enable signal of the voltage VO3, is output at a high level in the “inverting period of the voltage VO3”, only in such a case that both of the signal Vp3′ and the input signal to the input terminal CONT3 for an enable signal of the voltage VO3 are at the high level.

Also, an AND Vp4 output by the AND circuit 918, based on the signal Vp4′ and an input signal to the input terminal CONT4 for an enable signal of the voltage VO4, is output at a high level in the “inverting period of the voltage VO4”, only in such a case that both of the signal Vp4′ and the input signal to the input terminal CONT4 for an enable signal of the voltage VO4 are at the high level.

The signal Vp3 serves as the driving signal Vg5 so as to drive a gate of the third auxiliary switch SW5 constituted of an N-MOSFET. Because of this, the third auxiliary switch SW5 is turned ON only in the “inverting period of the voltage VO3”, only when the high level is input to the input terminal CONT3 for an enable signal of the voltage VO3. Also, the signal Vp3 is always output at a low level when the activating signal (enable signal) for the voltage VO3 is at the low level; therefore, in the case where it is not required to activate the voltage VO3, a path leading to the third output capacitor 43 can be closed by fixing the input terminal CONT3 at the low level, and resultantly the voltage VO3 is not output.

Also, the signal Vp4 serves as the driving signal Vg6 so as to drive a gate of the fourth auxiliary switch SW6 constituted of an N-MOSFET. Because of this, the fourth auxiliary switch SW6 is turned ON only in the “inverting period of the voltage VO4”, only when the high level is input to the input terminal CONT4 for an enable signal of the voltage VO4. Also, the signal Vp4 is always output at a low level when the activating signal (enable signal) for the voltage VO4 is at the low level; therefore, in the case where it is not required to activate the voltage VO4, a path leading to the fourth output capacitor 44 can be closed by fixing the input terminal CONT4 at the low level, and resultantly the voltage VO4 is not output.

Also, an inverted signal of the signal Vp1 inverted by the inverter 925 serves as the driving signal Vg2, so as to drive a gate of the first auxiliary switch SW2 constituted of a P-MOSFET. Because of this, the first auxiliary switch SW2 is turned ON only in the “step-up period of the voltage VO1”, only when the high level is input to the input terminal CONT1 for an enable signal of the voltage VO1. Also, the signal Vp1 is always output at a low level and the driving signal Vg2 always rises to the high level when the activating signal for the voltage VO1 is at the low level; therefore, in the case where it is not required to activate the voltage VO1, a path leading to the first output capacitor 41 can be closed by fixing the input terminal CONT1 at the low level, and resultantly the voltage VO1 is not output.

Also, an inverted signal of the signal Vp2 inverted by the inverter 926 serves as the driving signal Vg3, so as to drive a gate of the second auxiliary switch SW3 constituted of a P-MOSFET. Because of this, the second auxiliary switch SW3 is turned ON only in the “step-up period of the voltage VO2”, only when the high level is input to the input terminal CONT2 for an enable signal of the voltage VO2. Also, the signal Vp2 is always output at a low level and the driving signal Vg3 always rises to the high level when the activating signal for the voltage VO2 is at the low level; therefore, in the case where it is not required to activate the voltage VO2, a path leading to the second output capacitor 42 can be closed by fixing the input terminal CONT2 at the low level, and resultantly the voltage VO2 is not output.

The foregoing configuration allows exclusively selecting a discharge path of the energy from the inductor 2 to the plurality of capacitors 41, 42, 43, 44 through a time-division control, and selecting ON or OFF of a discharge path of the energy leading to the plurality of capacitors 41, 42, 43, 44 according to an enable signal defined in accordance with the respective output terminals of the voltages VO1 to VO4, i.e. according to an input status of the input terminals CONT1 to CONT4.

To the OR circuit 921, an AND of the signal V1 and the signal Vp1, and also an AND of the signal V2 and the signal Vp2 are input by the AND circuit 920, in addition to an inverted signal of the frequency division signal Vt3. And in the case where the input terminal CONT1 and the input terminal CONT2 are at the high level, the driving signal Vg1 rises to the high level in a period that the frequency division signal Vt3 is at the low level, a period that the signal V1 is at the high level and a period that the signal V2 is at the high level, so as to turn ON the first main switch SW1 constituted of an N-MOSFET.

Also, to the NOR circuit 924, an AND of the signal V3 and the signal Vp3, and also an AND of the signal V4 and the signal Vp4 are input by the AND circuit 922, in addition to the frequency division signal Vt3, and in the case where the input terminal CONT3 and the input terminal CONT4 are at the high level, the driving signal Vg4 falls to the low level in a period that the frequency division signal Vt3 is at the high level, a period that the signal V3 is at the high level and a period that the signal V4 is at the high level, so as to turn ON the second main switch SW4 constituted of a P-MOSFET.

As a result, in the “step-up period of the voltage VO1” of FIG. 10, the first main switch SW1 which is an N-MOSFET and the second main switch SW4 which is a P-MOSFET are simultaneously turned ON during a period that the signal V1 is at the high level, so that an electromagnetic energy is stored in the inductor 2. Subsequently, the signal V1 falls to the low level, and the driving signal Vg1 falls to the low level so as to turn OFF the first main switch SW1 which is an N-MOSFET. Then, since the driving signal Vg2 has provided a step-up path of the voltage VO1 in the “step-up period of the voltage VO1”, the electromagnetic energy stored in the inductor 2 starts to charge the capacitor 41 to a higher potential than the input DC voltage Ei through the diode 31.

Also, in the “step-up period of the voltage VO2” of FIG. 10, the first main switch SW1 which is an N-MOSFET and the second main switch SW4 which is a P-MOSFET are simultaneously turned ON during a period that the signal V2 is at the high level, so that an electromagnetic energy is stored in the inductor 2. Subsequently, the signal V2 falls to the low level, and the driving signal Vg1 falls to the low level so as to turn OFF the first main switch SW1 which is an N-MOSFET. Then, since the driving signal Vg3 has provided a step-up path of the voltage VO2 in the “step-up period of the voltage VO2”, the electromagnetic energy stored in the inductor 2 starts to charge the capacitor 42 to a higher potential than the input DC voltage Ei through the diode 32.

Then, in the “inverting period of the voltage VO3” of FIG. 10, the first main switch SW1 which is an N-MOSFET and the second main switch SW4 which is a P-MOSFET are simultaneously turned ON during a period that the signal V3 is at the high level, so that an electromagnetic energy is stored in the inductor 2. Subsequently, the signal V3 falls to the low level, and the driving signal Vg4 rises to the high level so as to turn OFF the second main switch SW4 which is a P-MOSFET. Then, since the driving signal Vg5 has provided a step-up path of the voltage VO3 in the “inverting period of the voltage VO3”, the electromagnetic energy stored in the inductor 2 starts to charge the capacitor 43 toward a negative potential through the diode 33.

Also, in the “inverting period of the voltage VO4” of FIG. 10, the first main switch SW1 which is an N-MOSFET and the second main switch SW4 which is a P-MOSFET are simultaneously turned ON during a period that the signal V4 is at the high level, so that an electromagnetic energy is stored in the inductor 2. Subsequently, the signal V4 falls to the low level, and the driving signal Vg4 rises to the high level so as to turn OFF the second main switch SW4 which is a P-MOSFET. Then, since the driving signal Vg6 has provided a step-up path of the voltage VO4 in the “inverting period of the voltage VO4”, the electromagnetic energy stored in the inductor 2 starts to charge the capacitor 44 toward a negative potential through the diode 34.

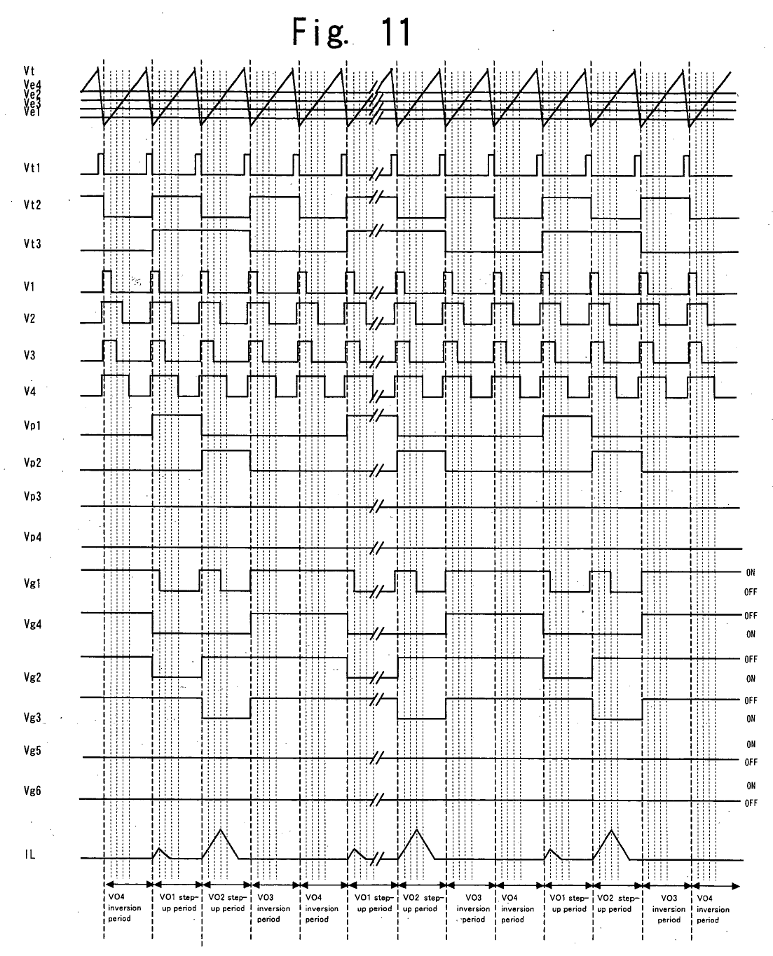

Now referring to FIGS. 9 and 11, such a case will be described that an input signal to the input terminal CONT3 for an enable signal of the voltage VO3 and an input signal to the input terminal CONT4 for an enable signal of the voltage VO4 are set at a low level as shown in FIG. 11.

Since the input signals to the input terminal CONT3 and the input terminal CONT4 are at the low level, the signal Vp3 and the signal Vp4 are also at the low level. Accordingly, output signals of the AND circuits 922, 923 are also at the low level, and nothing else but the frequency division signal Vt3 is input to the NOR circuit 924; therefore the NOR circuit 924 only outputs an inverted signal of the frequency division signal Vt3, and consequently the second main switch SW4 is turned ON only in a period that the frequency division signal Vt3 is at the high level.

Since the “inverting period of the voltage VO3” and the “inverting period of the voltage VO4” do not include a period that the first main switch SW1 and the second main switch SW4 are simultaneously turned ON, an electromagnetic energy for an inverting operation of the voltage VO3 and the voltage VO4 is not stored in the inductor 2.

Further, since the signal Vp3 and the signal Vp4 are at the low level, the third auxiliary switch SW5 and the fourth auxiliary switch SW6 both constituted of an N-MOSFET remains OFF, and the voltage VO3 and the voltage VO4 are not inverted because an inverting path to the voltage VO3 and the voltage VO4 are disconnected, and hence it becomes possible to boost only the output of the voltage VO1 and the voltage VO2.

Such operation is equivalent to that of the multi output DC-DC converter with two step-up channels described in the embodiment 1, and therefore a detailed description will be omitted.

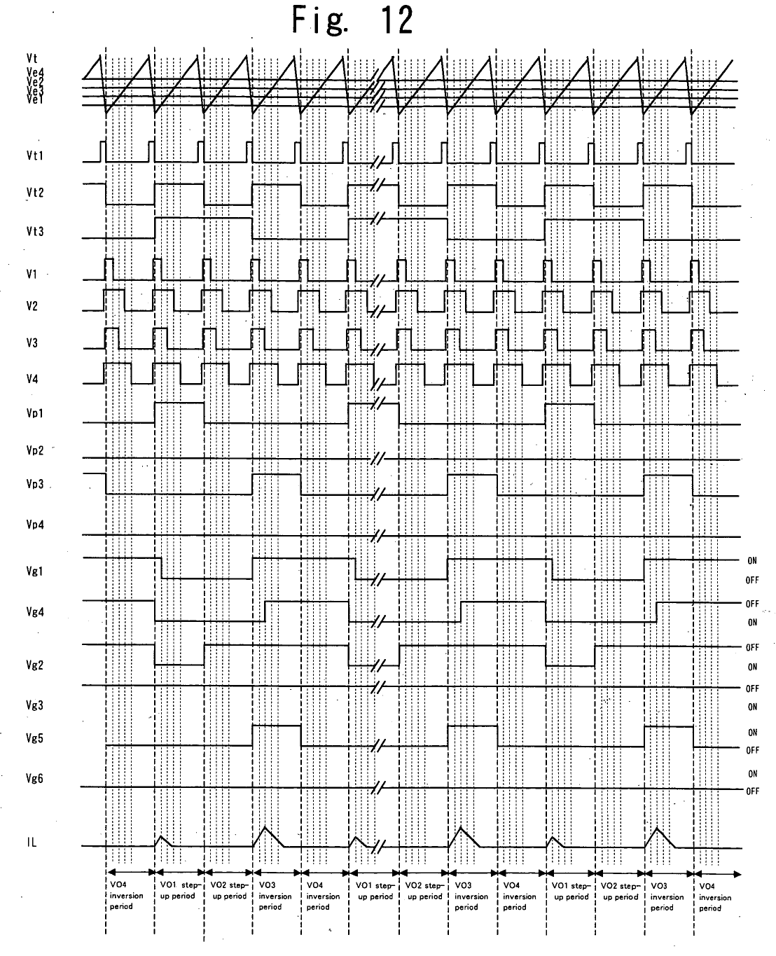

Now referring to FIGS. 9 and 12, such a case will be described that an input signal to the input terminal CONT2 for an enable signal of the voltage VO2 and an input signal to the input terminal CONT4 for an enable signal of the voltage VO4 are set at a low level as shown in FIG. 12.

Since the input signals to the input terminal CONT2 and the input terminal CONT4 are at the low level, the signal Vp2 and the signal Vp4 are also at the low level. Accordingly, an output signal of the AND circuit 919 is also at the low level, and the signal V1 is input to the OR circuit 921 by the AND circuit 920 in addition to an inverted signal of the frequency division signal Vt3, and the driving signal Vg1 rises to the high level only in a period that the frequency division signal Vt3 is at the low level and the signal V1 is at the high level, so as to turn ON the first main switch SW1 constituted of an N-MOSFET. Also, an output signal of the AND circuit 923 is also at the low level, and the signal V3 is input to the NOR circuit 924 by the AND circuit 922 in addition to the frequency division signal Vt3, and the driving signal Vg4 falls to the low level only in a period that the frequency division signal Vt3 is at the high level and the signal V3 is at the high level, so as to turn ON the second main switch SW4 constituted of a P-MOSFET.

As a result, since the “step-up period of the voltage VO2” and the “inverting period of the voltage VO4” do not include a period that the first main switch SW1 and the second main switch SW4 are simultaneously turned ON, an electromagnetic energy for a step-up operation of the voltage VO2 and an inverting operation of the voltage VO4 is not stored in the inductor 2.

Further, since the signal Vp2 and the signal Vp4 are at the low level, the high level is input to the second auxiliary switch SW3 constituted of a P-MOSFET and the low level is input to the fourth auxiliary switch SW6 constituted of an N-MOSFET; therefore the second auxiliary switch SW3 and the fourth auxiliary switch SW6 remains OFF, so as to disconnect a step-up path for the voltage VO2 and an inverting path of the voltage VO4. As a result, the step-up operation of the output voltage VO1, as well as the inverting operation of the output voltage VO3 can be executed, without executing the step-up operation of the output voltage VO2, nor the inverting operation of the output voltage VO4.

Such operation is equivalent to that of the multi output DC-DC converter with one step-up channel and one inverting channel described in the embodiment 2, and therefore a detailed description will be omitted.

While FIG. 11 shows the case where the converter is operated as a multi output DC-DC converter with two step-up channels for the output voltage VO1 and the output voltage VO2, by setting only the input terminal CONT1 and the input terminal CONT2 at a high level, and FIG. 12 the case where the converter is operated as a multi output DC-DC converter with one step-up channel and one inverting channel for the output voltage VO1 and the output voltage VO3, by setting only the input terminal CONT1 and the input terminal CONT3 at a high level, a high level and a low level of the input signals to the input terminals CONT1, CONT2, CONT3, CONT4 for the enable signal corresponding to the output voltages VO1, VO2, VO3, VO4 may be set as desired, and it is possible to activate or stop any of the output voltages VO1, VO2, VO3, VO4 at any desired timing.

The foregoing operation refers to a case of a multi output DC-DC converter that performs a time-division control at a quarter of an oscillating frequency, such that the output voltage VO1, the output voltage VO2, the output voltage VO3 and the output voltage VO4 repeat the step-up operation or inverting operation the same number of times, on the assumption that an output power consumption by the output voltage VO1, the output voltage VO2, the output voltage VO3 the output voltage VO4 are close to one another.

However, in the case where there is a certain difference among an output power consumption by the output voltage VO1, the output voltage VO2, the output voltage VO3 the output voltage VO4, it is preferable to make a difference among the number of times of the step-up operation and the number of times of the inverting operation. Accordingly, it is not necessary to alternately execute the step-up operation and the inverting operation with respect to each individual output terminal in the embodiment 3 too, as in the embodiment 1 and the embodiment 2.

Also, while the foregoing embodiment refers to the multi output DC-DC converter provided with two step-up output terminals and two inverted output terminals, the number of the step-up output terminals may be more than two. The number of the inverted output terminal may also be more than two.

### INDUSTRIAL APPLICABILITY

The multi output DC-DC converter according to the present invention offers the useful advantage of allowing setting each output voltage as desired irrespective of another output terminal, and starting to activate each output voltage at a different starting timing from another output voltage, and besides makes it possible to set an activating timing of a converting operation as desired with respect to a plurality of conversion DC voltages, so as to start outputting a plurality of conversion DC voltages at a desired timing.

1. A multi output DC-DC converter, comprising:
a DC power source which outputs an input DC voltage;
an inductor connected to said DC power source;
a main switch which is turned ON and OFF at a predetermined cycle, and applies said input DC voltage of said DC power source to said inductor when turned ON;
a plurality of rectifying means which rectify a voltage generated in said inductor when said main switch is off;
an auxiliary switches connected in series to each of said plurality of rectifying means;
a plurality of smoothing means connected to the respective series circuits of said plurality of rectifying means and said auxiliary switches, which respectively output a plurality of output voltages; and
a control circuit;
wherein said control circuit performs a time-division control of turning said main switch ON and OFF in said predetermined cycle, and of selecting one of said plurality of auxiliary switches in said predetermined cycle, to thereby output an output voltage through said selected auxiliary switch, and, in the case where an enable signal is instructing to stop, forcefully turns OFF said auxiliary switch corresponding to said enable signal.

2. The multi output DC-DC converter as defined in claim 1, wherein, said main switch is turned OFF during a period that an auxiliary switch for outputting the corresponding output voltage is selected, in the case where said enable signal is instructing to stop.

3. The multi output DC-DC converter as defined in claim 1, wherein said control circuit controls an energy storing time of said inductor such that said output voltage corresponding to said auxiliary switch matches a predetermined target voltage, during a period that an auxiliary switch for outputting the corresponding output voltage is selected, and causes said inductor to discharge a stored energy to said corresponding smoothing means among said plurality of smoothing means.

4. A multi output DC-DC converter, comprising:
a DC power source which outputs an input DC voltage;
an inductor;
a first main switch connected in series between said inductor and ground;
a second main switch connected in series between said DC power source and said inductor;
a first rectifying means connected to a node of said first main switch and said inductor;
a first smoothing means connected in series to said first rectifying means, for outputting a positive voltage;
a second rectifying means connected to a node of said second main switch and said inductor;
a second smoothing means connected in series to said second rectifying means, for outputting a negative voltage; and
a control circuit,
wherein said control circuit alternately selects a first state of outputting a positive voltage and a second state of outputting a negative voltage in a predetermined cycle; keeps said second main switch ON and turns said first main switch ON and OFF so as to rectify a voltage generated in said inductor with said first rectifying means, during a period of said first state; keeps said first main switch ON and turns said second main switch ON and OFF so as to rectify a voltage generated in said inductor with said second rectifying means, during a period of said second state; turns OFF said first main switch during a period that a first enable signal for a positive voltage is instructing to stop, but only during a period of said first state; and turns OFF said second main switch during a period that a second enable signal for a negative voltage is instructing to stop, but only during a period of said second state.

5. The multi output DC-DC converter as defined in claim 4, wherein
said control circuit controls an energy storing time of said inductor such that said output voltage corresponding to said auxiliary switch matches a predetermined target voltage, during a period of said first state or said second state, and causes said inductor to discharge a stored energy to said corresponding smoothing means among said plurality of smoothing means.
